(19) United States
(12) Patent Application Publication
(10) Pub. No.: US 2022/0011705 A1
(43) Pub. Date: Jan. 13, 2022

(54) IMAGE FORMING APPARATUS AND IMAGE FORMING METHOD

(71) Applicant: Yoshinori SHIRASAKI, Kanagawa (JP)

(72) Inventor: Yoshinori SHIRASAKI, Kanagawa (JP)

(73) Assignee: Ricoh Company, Ltd., Tokyo (JP)

(21) Appl. No.: 17/357,162

(22) Filed: Jun. 24, 2021

(30) Foreign Application Priority Data
Jul. 8, 2020 (JP) 2020-117855

(51) Int. Cl. G03G 15/00; G03G 15/043

(52) U.S. Cl. CPC G03G 15/5062; G03G 15/043; G03G 15/80

(57) ABSTRACT

An image forming apparatus includes: an image forming device configured to form a position detection pattern and a density detection pattern on a recording medium according to light emitted from an exposure device; a reading device configured to read the position detection pattern and the density detection pattern formed on the recording medium, the recording medium being conveyed in one of a plurality of orientations of the recording medium; and circuitry configured to correct a light intensity of the exposure device, based on the read position detection pattern and the read density detection pattern. For any one of the plurality of orientations of the recording medium, the position detection pattern is formed upstream of the density detection pattern in a sub-scanning direction.

### CROSS-REFERENCE TO RELATED APPLICATIONS

This patent application is based on and claims priority pursuant to 35 U.S.C. § 119(a) to Japanese Patent Application No. 2020-117855, filed on Jul. 8, 2020, in the Japan Patent Office, the entire disclosure of which is hereby incorporated by reference herein.

### BACKGROUND

### Technical Field

Embodiments of the present disclosure relate to an image forming apparatus and an image forming method.

### Description of the Related Art

A light emitting diode (LED) head (an example of an exposure device) included in an image forming device may contain variations in shape, characteristics, and the like from one LED element to another, minute deviations in the arrangement of LED chips, periodic or non-periodic changes in the optical characteristics of a lens array. In this case, an image formed by the image forming device may have density unevenness such as vertical streaks and vertical bands, resulting in a reduction in the quality of the image. Accordingly, a technique has been developed for correcting the light intensity of the LED head to correct the density unevenness described above.

A technique such as scanner feedback (FB) vertical streak correction has also been developed in which a test chart drawn on a density detection pattern formed by the LED head is read by a reading device, a correction value for reducing vertical streaks, vertical band, and the like is calculated based on the density of the read density detection pattern and is stored in a memory in the LED head, and, at the printing time, an image is formed using the correction value to correct unevenness such as vertical streaks and vertical bands caused by the LED head.

In the scanner FB vertical streak correction, to prevent the correction from being performed a plurality of times due to a reduction in the correction accuracy of density unevenness caused by inclination of a document (an example of a recording medium), a technique has been developed for correcting an inclination component of the document based on position information of markers formed on the upstream and downstream in the conveyance direction of the document. In this technique, if a document is set in the reading device in an incorrect orientation, the reading device may read the document again.

### SUMMARY

According to an embodiment of the present disclosure, an image forming apparatus includes: an image forming device that forms a position detection pattern and a density detection pattern on a recording medium according to light emitted from an exposure device; a reading device that reads the position detection pattern and the density detection pattern formed on the recording medium, the recording medium being conveyed in one of a plurality of orientations of the recording medium; and circuitry that corrects a light intensity of the exposure device, based on the read position detection pattern and the read density detection pattern. For any one of the plurality of orientations of the recording medium, the position detection pattern is formed upstream of the density detection pattern in a sub-scanning direction.

According to another embodiment of the present disclosure, a method for correcting a light intensity, includes: forming a position detection pattern and a density detection pattern on a recording medium according to light emitted from an exposure device; reading the position detection pattern and the density detection pattern formed on the recording medium, the recording medium being conveyed in one of a plurality of orientations of the recording medium; and correcting a light intensity of the exposure device, based on the read position detection pattern and the read density detection pattern. For any one of the plurality of orientations of the recording medium, the position detection pattern is formed upstream of the density detection pattern in a sub-scanning direction

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an example configuration of an image forming apparatus according to an embodiment;

FIG. 2 is a flowchart illustrating an example operation performed by the image forming apparatus according to the embodiment;

FIG. 3 is a diagram illustrating an example image density acquisition process, performed by the image forming apparatus according to the embodiment;

FIG. 4 is a diagram illustrating an example position detection pattern to be formed on a recording medium by the image forming apparatus according to the embodiment;

FIG. 5 is a flowchart illustrating an example process for detecting an inspection pattern by the image forming apparatus according to the embodiment;

FIG. 6 is a diagram illustrating an example conveyance direction of a recording medium in the image forming apparatus according to the embodiment;

FIG. 7 is a diagram illustrating an example configuration of a reading device included in the image forming apparatus according to the embodiment;

FIG. 8 is a diagram illustrating example combinations of inspection patterns and orientations of a recording medium placed in the reading device of the image forming apparatus according to the embodiment;

FIG. 9 is a diagram illustrating example reading results of a recording medium in the image forming apparatus according to the embodiment; and

FIG. 10 is a diagram illustrating a schematic diagram illustrating an example hardware configuration of the image forming apparatus according to the embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image forming apparatus and an image forming method according to an embodiment will be described in detail hereinafter with reference to the accompanying drawings.

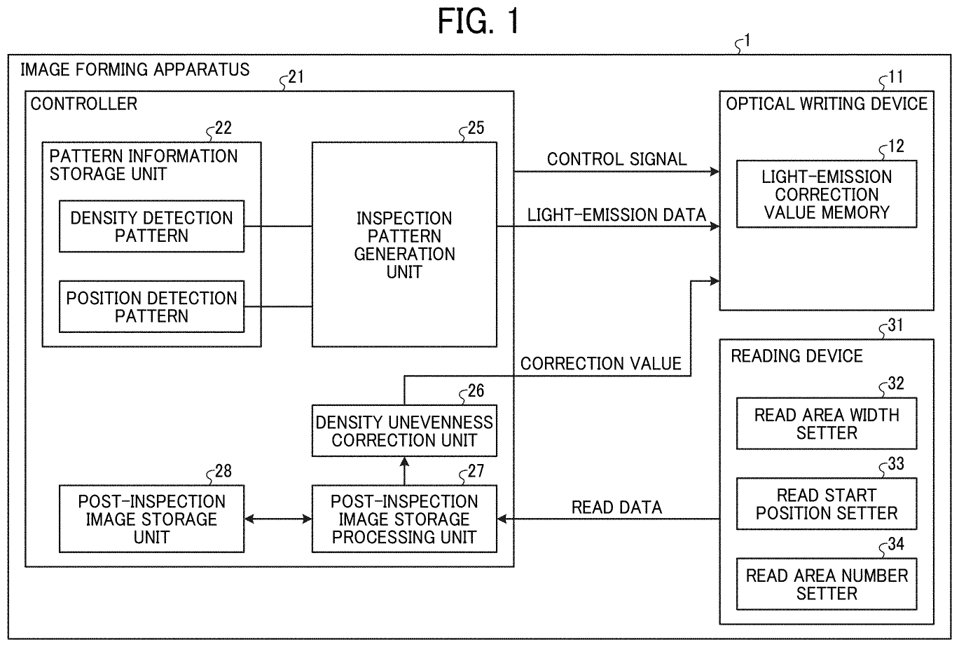

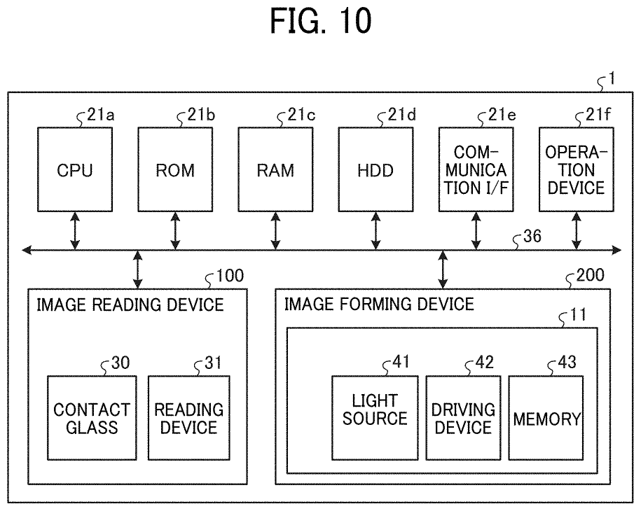

FIG. 1 is a block diagram illustrating an example functional configuration of an image forming apparatus according to this embodiment. FIG. 10 is a block diagram illustrating an example hardware configuration of the image forming apparatus of FIG. 1. First, an example configuration of an image forming apparatus 1 according to this embodiment will be described with reference to FIGS. 1 and 10.

As illustrated in FIG. 1, the image forming apparatus 1 according to this embodiment includes an optical writing device 11, a controller 21, and a reading device 31. As described below referring to FIG. 10, the optical writing device 11 is an example of an image forming device that forms an image. The controller 21 is implemented by a central processing unit (CPU) and a memory, for example. The reading device 31 is a scanner, for example.

Referring now to FIG. 10, an example hardware configuration of the image forming apparatus 1 is described.

As illustrated in FIG. 1, the image forming apparatus 1 includes the controller 21, which includes a central processing unit (CPU) 21a, a read only memory (ROM) 21b, a random access memory (RAM) 21c, a hard disk drive (HDD) 21d, a communication interface (I/F) 21e, and an operation device 21f. The image forming apparatus 1 further includes an image reading device 100 including the reading device 31, and an image forming device 200 including the optical writing device 11. These components are connected which each other via a system bus 36.

The CPU 21a controls the operation of the image forming apparatus 1. The CPU 21a executes a program stored in the ROM 21b or the HDD 21d by using the RAM 21c as a work area. Thereby, the CPU 21a controls the overall operation of the image forming apparatus 1 to implement various functions such as a copier function, a scanner function, a facsimile (FAX) function, and a printer function. Each time an operation is performed by one of these various functions, the operation (hereinafter occasionally referred to as the job) is storable in the HDD 21d as an operation log of the image forming apparatus 1.

The communication I/F 21e is an interface that receives a job from an external apparatus via a network and transmits a read image read and formed by the reading device 31 to the outside of the image forming apparatus 1 via the network.

The operation device 21f receives various inputs according to operations performed by an operator (hereinafter referred to as the user). The operation device 21f further displays various information such as information representing a received operation, information representing the operating status of the image forming apparatus 1, and information representing the setting status of the image forming apparatus 1, for example. The operation device 21f is implemented with, but not limited to, a liquid crystal display (LCD) equipped with a touch panel function, for example. For instance, the operation device 21f may be implemented with an organic electroluminescence (EL) display equipped with the touch panel function. In addition to or in place of the display, the operation device 21f may include an operation section including hardware keys and a display section including lamps.

The image reading device 100 includes a contact glass 30 and a reading device 31. The contact glass 30 is an example of a reading table on which a recording medium is placed. The recording medium is, for example, a sheet on which a pattern is to be formed by the image forming device 200. The reading device 31 reads the pattern formed on the recording medium and generates image data of the pattern.

The image forming device 200 includes a photoconductor drum (an example of a photoconductor), a charging device, an exposure device, a developing device, a transfer device, and a fixing device. The image forming device 200 forms a pattern on the recording medium. The charging device charges a surface of the photoconductor drum. The exposure device irradiates the charged surface of the photoconductor drum with light to form thereon an electrostatic latent image.

Specifically, the exposure device includes a light source 41, a driving device 42, and a memory 43. The light source 41 is a light emitting diode (LED) array head or a laser diode (LD) unit, for example. The light source 41 is an example of a light emitting element that irradiates the surface of the photoconductor drum with irradiation light corresponding to the pattern to be formed on the recording medium, to thereby form an electrostatic latent image on the surface of the photoconductor drum. The driving device 42 is implemented with a driver integrated circuit (IC), for example. The driving device 42 drives the light source 41 to turn on based on the image data. The memory 43, which may be implemented by a ROM, stores information and settings for the driving device 42 to drive the light source 41.

The developing device adheres toner to the electrostatic latent image formed on the surface of the photoconductor drum, to thereby form a toner image on the surface of the photoconductor drum. The transfer device transfers the toner image formed on the surface of the photoconductor drum to the recording medium. The fixing device fixes the toner image on the recording medium.

Referring back to FIG. 1, a functional configuration of the image forming apparatus 1 is described according to the embodiment.

The optical writing device 11 is a part of the image forming device 200 including an exposure device such as an LED. The optical writing device 11 forms various images such as a position detection pattern and a density detection pattern on a recording medium in response to light emitted from the exposure device, based on image data (light-emission data) input from the controller 21. The density detection pattern is an image to be used to correct unevenness in the density of an image formed on a recording medium by the optical writing device 11. For example, the density detection pattern is an image (halftone image) having uniform density in a sub-scanning direction, which is the conveyance direction of the recording medium, and a main-scanning direction orthogonal to the sub-scanning direction. The position detection pattern is an image for detecting the position of a light-emitting element that forms the density detection pattern read by the reading device 31 among light-emitting elements of the exposure device included in the optical writing device 11.

In this embodiment, the optical writing device 11 includes a light-emission correction value memory 12, which is implemented by the memory 43, for example. The light-emission correction value memory 12 is a memory that stores a correction value of the intensity of light emitted from the exposure device. The optical writing device 11 emits light from the exposure device in accordance with the correction value stored in the light-emission correction value memory 12.

The reading device 31 is an example of a reading device that reads a position detection pattern and a density detection pattern formed on a recording medium by the optical writing device 11. In this embodiment, the reading device 31 includes, as functions, a read area width setter 32, a read start position setter 33, and a read area number setter 34.

The read area width setter 32 sets the size of a read area. The read area is an area to be read in the recording medium. The read start position setter 33 sets a read start position. The read start position is a position at which the reading of the recording medium is started. The read area number setter 34 sets the number of read areas in the recording medium. The reading device 31 reads the position detection pattern and the density detection pattern formed on the recording medium in accordance with the size of the read area set by the read area width setter 32, the read start position set by the read start position setter 33, and the number of read areas set by the read area number setter 34.

The controller 21 controls the entire image forming apparatus 1. In this embodiment, the controller 21 includes a pattern information storage unit 22, an inspection pattern generation unit 25, a density unevenness correction unit 26, a post-inspection image storage processing unit 27, and a post-inspection image storage unit 28. The inspection pattern generation unit 25, the density unevenness correction unit 26, and the post-inspection image storage processing unit 27 are functions to be executed by the CPU 21a, in accordance with a control program stored in a memory such as the ROM 21b. The pattern information storage unit 22 and the post-inspection image storage unit 28 are each implemented by a memory, such as the ROM 21b, RAM 21c, or HDD 21d.

The inspection pattern generation unit 25 is an example of a generation unit that generates an inspection pattern including a position detection pattern and a density detection pattern. The pattern information storage unit 22 stores the inspection pattern generated by the inspection pattern generation unit 25.

The post-inspection image storage processing unit 27 stores a post-inspection image (read data) in the post-inspection image storage unit 28. The post-inspection image is an image read from the recording medium by the reading device 31. The post-inspection image storage unit 28 stores the post-inspection image read by the reading device 31.

The density unevenness correction unit 26 corrects unevenness in the density of an image formed on the recording medium, based on the post-inspection image stored in the post-inspection image storage unit 28. In this embodiment, the density unevenness correction unit 26 functions as an example of a correction unit that corrects the light intensity of the exposure device included in the optical writing device 11 based on the post-inspection image (i.e., the read position detection pattern and density detection pattern) to correct unevenness in the density of the image formed on the recording medium.

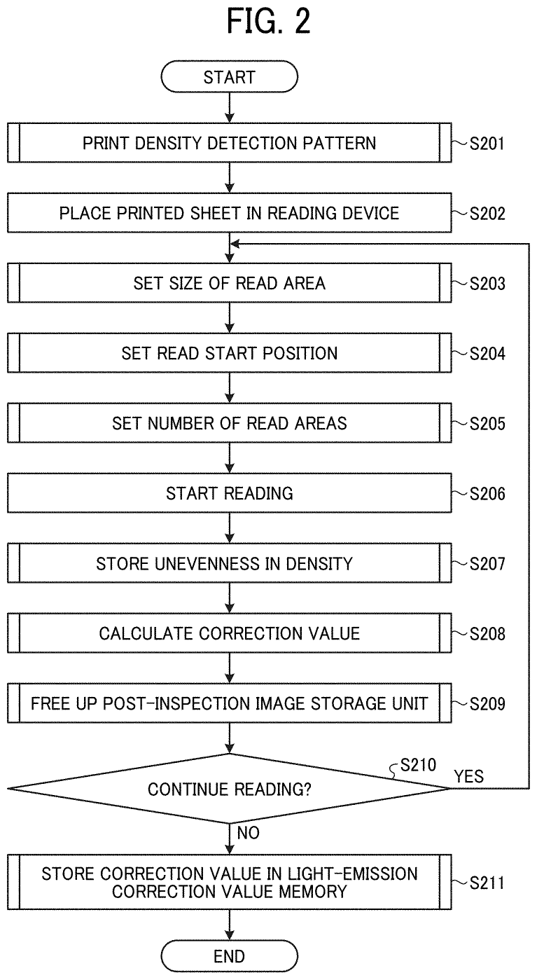

FIG. 2 is a flowchart illustrating an example basic operation of the image forming apparatus 1 according to this embodiment. An example basic operation of the image forming apparatus 1 according to this embodiment will be described with reference to FIG. 2.

First, the optical writing device 11 prints (forms) an inspection pattern including a position detection pattern and a density detection pattern on a recording medium in response to light emitted from the exposure device, based on image data (inspection pattern) generated by the inspection pattern generation unit 25 (step S201).

When the recording medium with an inspection image (inspection pattern) printed thereon, such as a sheet, is placed in the reading device 31 (step S202), the read area width setter 32 sets the size of a read area (step S203). Further, the read start position setter 33 sets read start positions in the conveyance direction of the recording medium (sub-scanning direction) and the main-scanning direction orthogonal to the sub-scanning direction (step S204). Further, the read area number setter 34 sets the number of read areas (step S205).

The reading device 31 starts reading the image formed on the recording medium (unevenness in the density of the image formed on the recording medium) in accordance with the size of the read area set by the read area width setter 32, the read start position set by the read start position setter 33, and the number of read areas set by the read area number setter 34 (step S206).

The post-inspection image storage processing unit 27 stores the post-inspection image (unevenness in the density of the image formed on the recording medium), which is the image read by the reading device 31, in the post-inspection image storage unit 28 (step S207). The density unevenness correction unit 26 calculates a correction value for correcting unevenness in the density of the image formed on the recording medium, based on the post-inspection image stored in the post-inspection image storage unit 28 (step S208).

Then, the post-inspection image storage processing unit 27 deletes the post-inspection image stored in the post-inspection image storage unit 28 to free up the post-inspection image storage unit 28 (step S209). Then, the reading device 31 determines whether to continue reading the image formed on the recording medium (step S210). When the reading of the image formed on the recording medium is continued (step S210: Yes), the process returns to step S203.

On the other hand, when the reading of the image formed on the recording medium is finished (step S210: No), the density unevenness correction unit 26 stores the calculated correction value in the light-emission correction value memory 12 of the optical writing device 11 (step S211). Accordingly, the density unevenness correction unit 26 corrects the intensity of light emitted from the exposure device included in the optical writing device 11.

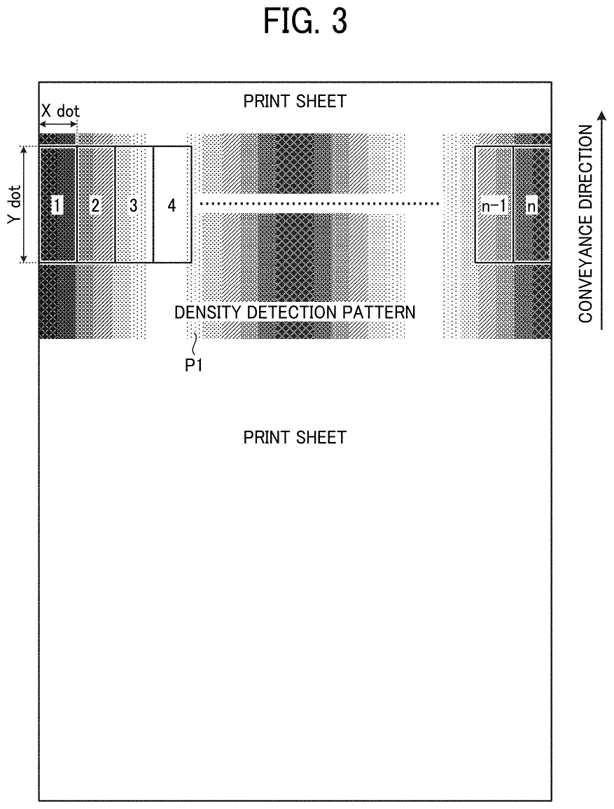

FIG. 3 is a diagram illustrating an example image density acquisition process using the image forming apparatus 1 according to this embodiment. An example image density acquisition process using the image forming apparatus 1 according to this embodiment will be described with reference to FIG. 3.

In this embodiment, as illustrated in FIG. 3, the optical writing device 11 forms (prints) a density detection pattern P1 on a print sheet, which is an example of a recording medium. At this time, as illustrated in FIG. 3, the optical writing device 11 forms, as the density detection pattern P1, a halftone image having uniform density in the sub-scanning direction, which is the conveyance direction of the print sheet, and the main-scanning direction, which is a direction orthogonal to the sub-scanning direction.

In the density detection pattern P1, unevenness in density such as vertical streaks or vertical bands is caused by optical variations of the LED head, which is an example of the exposure device included in the optical writing device 11, or variations unique to engines for image formation. The density of the density detection pattern P1 may be an average density of an area of X dots in the main-scanning direction and Y dots in the sub-scanning direction.

For example, to acquire the density of an image in the vertical direction (main-scanning direction) of a print sheet of A4 when X is set to be equal to 1 dot, the reading device 31 acquires the density of areas given by 210 mm×(600 dpi/25.4 mm), that is, approximately 4,960 areas, within the density of the read image. When the acquired density is expressed by 8 bits (0 to 255), a storage capacity of 4,960×8 bits=4.96 kBytes is used. Setting X to be equal to 2 dots or 4 dots reduces the storage capacity to be used to store the density to ½ or ¼, as compared to the case of setting X to be equal to 1 dot.

The value Y does not affect the storage capacity and is thus desirably set by taking into account the unevenness in density in the sub-scanning direction of the image forming apparatus 1, such as periodic unevenness in density caused by a photoconductor, a transfer belt, a developing roller, and the like and other non-periodic unevenness in density, and set to a value that does not cause a difference in the acquired density due to the influence of such unevenness in density. When the value Y is set to be excessively large, it may take time to acquire the density. Thus, it is desirable to set the value Y in consideration of the accuracy with which the density is acquired and the time taken to acquire the density.

When the position of the density detection pattern P1 in the sub-scanning direction is fixed relative to the leading end of the print sheet, the timing at which the reading device 31 acquires the density can be fixed. However, when the position of the density detection pattern P1 in the sub-scanning direction is set to any position relative to the leading end of the print sheet, the timing at which the reading device 31 acquires the density is set to be variable.

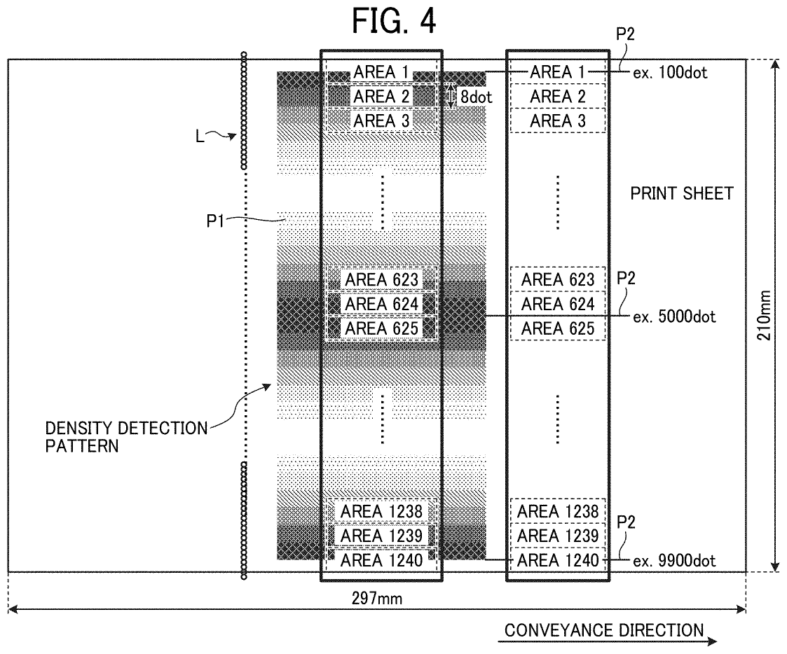

FIG. 4 is a diagram illustrating an example position detection pattern to be formed on a recording medium by the image forming apparatus 1 according to this embodiment. An example position detection pattern to be formed on a recording medium by the image forming apparatus 1 according to this embodiment will be described with reference to FIG. 4.

In this embodiment, as illustrated in FIG. 4, the optical writing device 11 forms (prints) position detection patterns P2 for detecting the position of a light-emitting element (exposure device) included in the optical writing device 11, in addition to the density detection pattern P1, on the print sheet, which is an example of a recording medium. The position detection patterns P2 are patterns for detecting the position of a light-emitting element L that forms the density detection pattern P1 read by the reading device 31 among light-emitting elements L of the exposure device included in the optical writing device 11.

Accordingly, the light-emitting element L of the exposure device included in the optical writing device 11 can be associated with the area of the density detection pattern P1 read by the reading device 31. Thus, even in the case of a deviation of the printing position of the density detection pattern P1 caused by variations in the manner of conveyance of print sheets or variations in the setting of print sheets in the reading device 31, the intensity of light emitted from the exposure device included in the optical writing device 11 can be accurately corrected.

In addition, the number of areas (distance) between the position detection patterns P2 may be different from an ideal value (for example, there may be a magnification error) due to extension or contraction of a print sheet during printing, an error during scanning, or the like. In this case, the light-emitting element L associated with the area read by the reading device 31 is changed in increments of 1 dot. This makes it possible to bring the number of areas between the position detection patterns P2 close to the ideal value. This embodiment describes an example in which an LED array head is applied to the light-emitting elements L included in the optical writing device 11. Alternatively, the light-emitting elements L may be implemented using laser diodes (LDs). Also in this case, the intensity of light emitted from the exposure device included in the optical writing device 11 can be accurately corrected.

When the positions of the position detection patterns P2 in the sub-scanning direction are fixed relative to the leading end of the print sheet, the timing at which the reading device 31 acquires the density (i.e., the timing at which the reading device 31 reads an image) can be fixed. However, if the positions of the position detection patterns P2 in the sub-scanning direction are set to any positions relative to the leading end of the print sheet, the timing at which the reading device 31 reads an image is set to be variable.

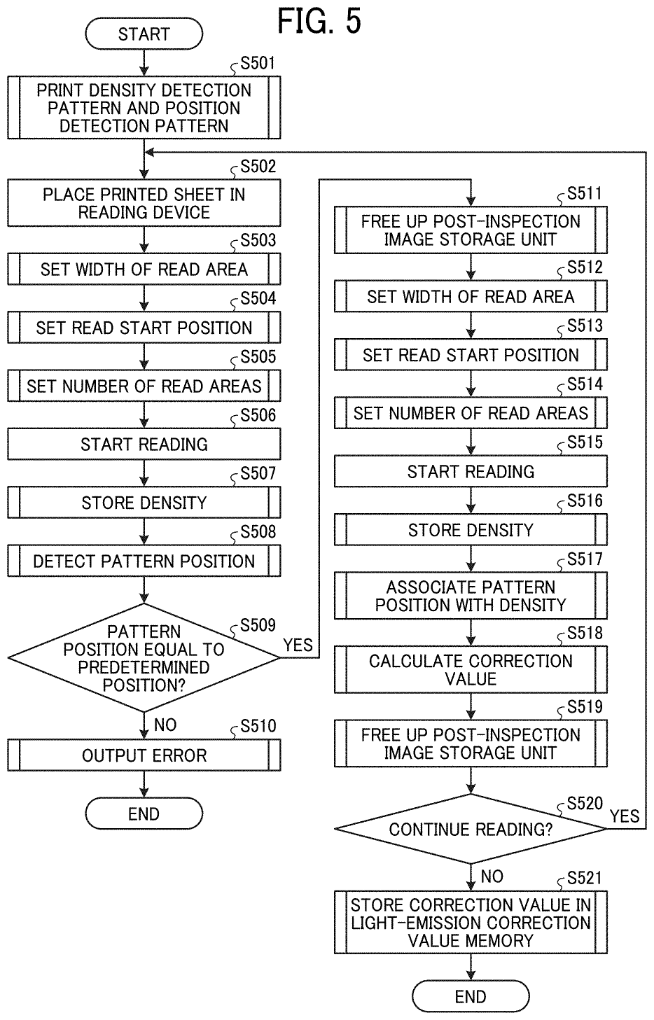

FIG. 5 is a flowchart illustrating an example process for detecting an inspection pattern using the image forming apparatus 1 according to this embodiment. An example process for detecting (reading) an inspection pattern using the image forming apparatus 1 according to this embodiment will be described with reference to FIG. 5.

The optical writing device 11 prints (forms) a density detection pattern and a position detection pattern on a recording medium in response to light emitted from the exposure device, based on image data of an inspection pattern generated by the inspection pattern generation unit 25 (step S501).

When the recording medium with the density detection pattern and the position detection pattern printed thereon, such as a sheet, is placed in the reading device 31 (step S502), the read area width setter 32 sets the width (size) of a read area (step S503). Further, the read start position setter 33 sets a read start position for each of the sub-scanning direction and the main-scanning direction of the recording medium (step S504). Further, the read area number setter 34 sets the number of read areas (step S505).

Then, the reading device 31 starts reading the recording medium in accordance with the set size of the read area, the set read start position, and the set number of read areas (step S506). The reading device 31 stores the density of the post-inspection image read from the recording medium in the post-inspection image storage unit 28 via the post-inspection image storage processing unit 27 (step S507).

The density unevenness correction unit 26 detects a pattern position, which is the position of the position detection pattern, based on the density of the post-inspection image stored in the post-inspection image storage unit 28 (step S508), and determines whether the detected pattern position is equal to a predetermined position (step S509). When it is determined that the detected pattern position is not equal to the predetermined position (step S509: No), the density unevenness correction unit 26 outputs an error (step S510). The predetermined position is a correct position of the position detection pattern, which is set in advance. Specifically, the predetermined position is located upstream of the density detection pattern in the conveyance direction of the recording medium.

On the other hand, when it is determined that the detected pattern position is equal to the predetermined position (step S509: Yes), the density unevenness correction unit 26 deletes the density of the post-inspection image stored in the post-inspection image storage unit 28 via the post-inspection image storage processing unit 27 to free up the post-inspection image storage unit 28 (step S511). Then, the read area width setter 32 sets the width (size) of a read area (step S512). Further, the read start position setter 33 sets a read start position for each of the sub-scanning direction and the main-scanning direction of the recording medium (step S513). Further, the read area number setter 34 sets the number of read areas (step S514).

Then, the reading device 31 starts reading the recording medium in accordance with the set size of the read area, the set read start position, and the set number of read areas (step S515). The reading device 31 stores the density of the post-inspection image read from the recording medium in the post-inspection image storage unit 28 via the post-inspection image storage processing unit 27 (step S516).

Then, the density unevenness correction unit 26 associates the pattern position (i.e., light-emitting element) detected in step S508 with the density of the density detection pattern read from the recording medium in step S515 (step S517). The density unevenness correction unit 26 calculates a correction value of the intensity of light emitted from the light-emitting element at the detected pattern position, based on the density of the density detection pattern (step S518). Then, the post-inspection image storage processing unit 27 deletes the density of the post-inspection image stored in the post-inspection image storage unit 28 to free up the post-inspection image storage unit 28 (step S519).

The reading device 31 determines whether to continue reading the recording medium (step S520). when the reading of the recording medium is continued (step S520: Yes), the process returns to step S502. On the other hand, when the reading of the recording medium is finished (step S520: No), the density unevenness correction unit 26 stores the calculated correction value in the light-emission correction value memory 12 included in the optical writing device 11 (step S521).

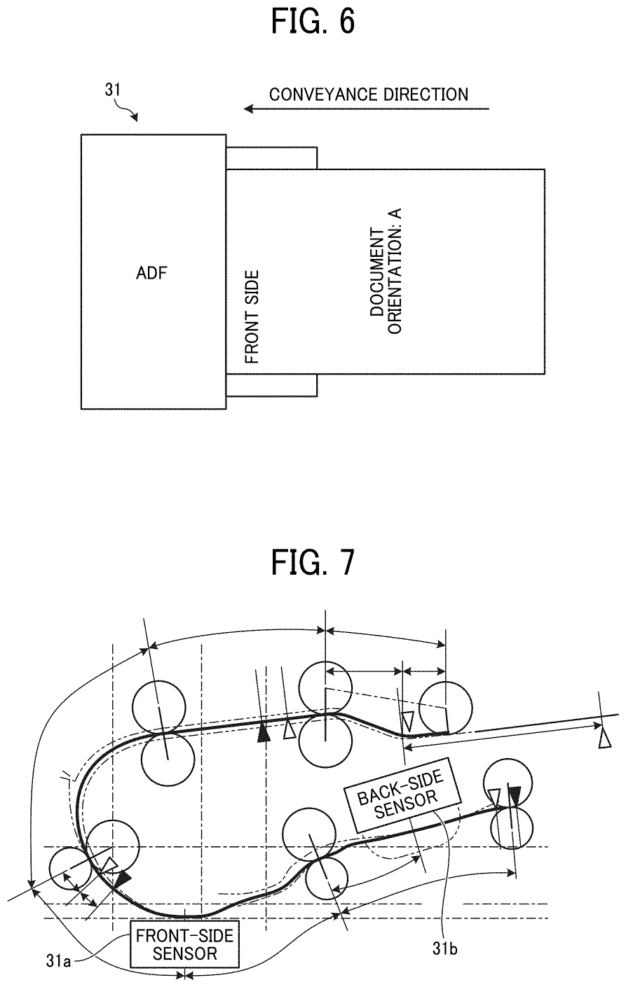

FIG. 6 is a diagram illustrating an example conveyance direction of a recording medium in the image forming apparatus 1 according to this embodiment. An example conveyance direction of a recording medium in the image forming apparatus 1 according to this embodiment will be described with reference to FIG. 6.

For example, when the print sheet illustrated in FIG. 4 (an example of a recording medium) is read by the reading device 31 after being rotated by 180 degrees, it is difficult to detect the position detection patterns P2 at the predetermined positions. In this case, it is difficult to detect the position of the light-emitting element that forms the density detection pattern P1 read by the reading device 31. Thus, the density unevenness correction unit 26 determines an error, and it is difficult to correct density unevenness such as vertical streaks and vertical bands of an image formed on the recording medium. Thus, the user of the image forming apparatus 1 again places the recording medium in the reading device 31.

Specifically, as illustrated in FIG. 6, the print sheet is placed in an auto document feeder (ADF) of the reading device 31 in a document orientation a such that the position detection patterns P2 are located upstream of the density detection pattern P1 in the conveyance direction of the print sheet. The orientation of the print sheet when placed in the ADF after being rotated by 180 degrees with respect to the document orientation a is represented by a document orientation b. The orientation of the print sheet when placed upside down in the ADF is represented by a document orientation c. The orientation of the print sheet when placed in the ADF after being rotated by 180 degrees with respect to the document orientation c is represented by a document orientation d.

When the print document is placed in the ADF of the reading device 31 in the document orientation a, the position detection patterns P2 are detected at the predetermined positions. Accordingly, the density unevenness correction unit 26 can detect the position of the light-emitting element that forms the density detection pattern P1, and correct the intensity of light emitted from the exposure device of the optical writing device 11. When the print document is placed in the ADF of the reading device 31 in the document orientation b, in contrast, it is difficult to detect the position detection patterns P2 at the predetermined positions. Accordingly, the density unevenness correction unit 26 fails to detect the position of the light-emitting element that forms the density detection pattern P1 and correct the intensity of light emitted from the exposure device of the optical writing device 11.

When the print document is placed in the ADF of the reading device 31 in the document orientation c or d, it is difficult to detect the position detection patterns P2 at the predetermined positions. Accordingly, the density unevenness correction unit 26 fails to detect the position of the light-emitting element that forms the density detection pattern P1 read by the reading device 31 and correct the intensity of light emitted from the exposure device of the optical writing device 11.

FIG. 7 is a diagram illustrating an example configuration of the reading device 31 included in the image forming apparatus 1 according to this embodiment. An example configuration of the reading device 31 included in the image forming apparatus 1 according to this embodiment will be described with reference to FIG. 7.

For example, the reading device 31 included in the image forming apparatus 1 may be a reading device of a duplex scanning type (single-pass duplex scanning configuration) capable of reading both the front and back sides of a print sheet, which is an example of a recording medium, by reading the print sheet once. As illustrated in FIG. 7, the reading device 31 of the duplex scanning type includes a front-side sensor 31a and a back-side sensor 31b. When a print sheet is set in the ADF and the reading device 31 starts a reading operation, the front-side sensor 31a reads the front side of the print sheet, and the back-side sensor 31b reads the back side of the print sheet.

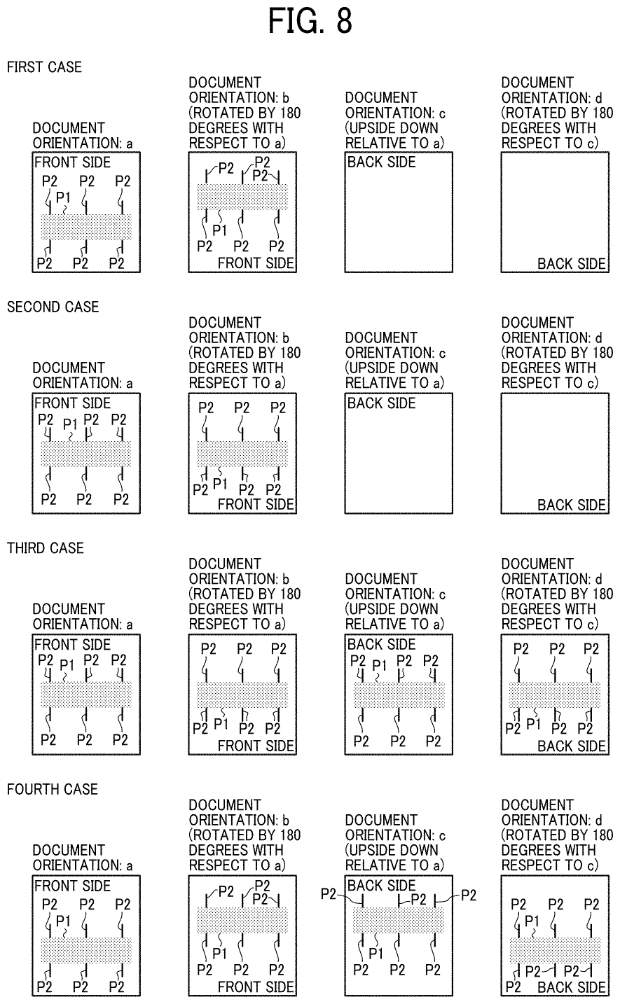

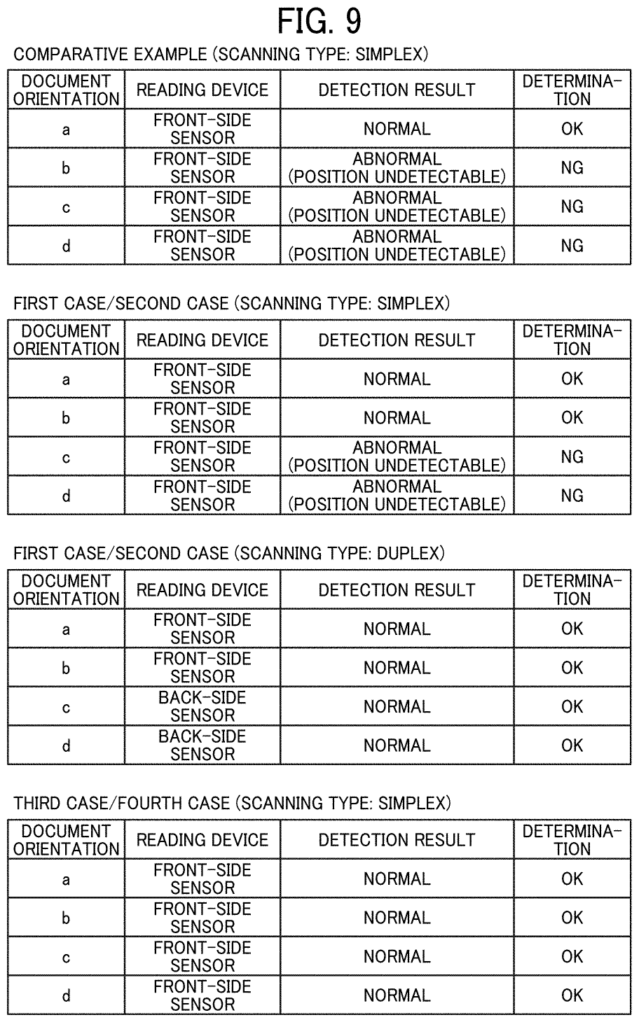

FIG. 8 is a diagram illustrating example combinations of inspection patterns and orientations of a recording medium placed in the reading device 31 of the image forming apparatus 1 according to this embodiment. FIG. 9 is a diagram illustrating example reading results of a recording medium in the image forming apparatus 1 according to this embodiment. Example reading results of a recording medium by the reading device 31 of the image forming apparatus 1 according to this embodiment will be described with reference to FIGS. 8 and 9.

In the example illustrated in FIG. 4, the optical writing device 11 forms the position detection patterns P2 on a first portion of the print sheet and the density detection pattern P1 on a second portion of the print sheet, such that the first portion is upstream and the second portion is downstream in the conveyance direction (that is, the sub-scanning direction) of the print sheet.

According to the comparative example, in a case where the reading device 31 is of a simplex scanning type capable of reading only one side of a print document, when the orientation of the print sheet is the document orientation a (see FIG. 6), as illustrated in FIG. 9, the density unevenness correction unit 26 detects the position detection patterns P2 located at the predetermined positions from the reading result of the front-side sensor 31a. When the orientation of the print sheet is the document orientation b, c, or d, however, as illustrated in FIG. 9, the density unevenness correction unit 26 fails to detect the position detection patterns P2 located at the predetermined positions from the reading result of the front-side sensor 31a. In the technique of the comparative example described above, in a case where the reading device 31 is of the duplex scanning type capable of reading both sides of a print sheet, when the orientation of the print sheet is the document orientation a (see FIG. 6) or c, the density unevenness correction unit 26 can detect the position detection patterns P2 located at the predetermined positions from the reading result of the front-side sensor 31a or the back-side sensor 31b.

In this embodiment, accordingly, the optical writing device 11 forms, the position detection patterns P2 on a first portion of the print sheet and the density detection pattern P1 on a second portion of the print sheet, such that the first portion is upstream and the second portion is downstream in the conveyance direction (that is, the sub-scanning direction) of the print sheet, irrespective of an orientation of the print sheet. Thus, even if a print sheet is conveyed in either the document orientation a or b, the position detection patterns P2 can be detected at the predetermined positions. As a result, it is possible to prevent a print sheet from being re-read when correcting density unevenness such as vertical streaks and vertical bands of an image, and it is possible to improve usability.

In this embodiment, as illustrated in FIG. 8, the optical writing device 11 forms position detection patterns P2 both upstream and downstream of one density detection pattern P1 in the conveyance direction of a print sheet. Accordingly, even when the print sheet is conveyed in either the document orientation a or b, the position detection patterns P2 located at predetermined positions can be detected.

For example, in a first case, as illustrated in FIG. 8, the optical writing device 11 forms the position detection patterns P2 and the density detection pattern P1 at positions on one side (for example, the front side) of a print sheet in the conveyance direction of the print sheet. At this time, as illustrated in FIG. 8, the optical writing device 11 forms the position detection patterns P2 both upstream and downstream of the density detection pattern P1 in the conveyance direction.

In the first case, accordingly, as illustrated in FIG. 9, in a case where the reading device 31 is of the simplex scanning type, the position detection patterns P2 located at the predetermined positions can be detected even when the print sheet is conveyed in either of the document orientations a and b. In the first case, furthermore, as illustrated in FIG. 9, in a case where the reading device 31 is of the duplex scanning type, the position detection patterns P2 located at the predetermined positions can be detected even when the print sheet is conveyed in any one of the document orientations a, b, c, and d.

In the first case, however, the position at which the reading device 31 starts reading the print sheet changes depending on the orientation of the print sheet in the conveyance direction, leading to an increase in the complexity of the process of setting the read start position, which is performed by the read start position setter 33. For example, the processing of steps S503 to S508 in the flowchart illustrated in FIG. 5 is repeatedly performed until the position detection patterns P2 are successfully read by the reading device 31. In the first case, since the density detection pattern P1 formed on the print sheet does not change, the amount of toner consumed by the formation of the density detection pattern P1 does not change.

For example, in a second case, as illustrated in FIG. 8, the optical writing device 11 forms the position detection patterns P2 and the density detection pattern P1 at the center on one side (for example, the front side) of a print sheet in the conveyance direction of the print sheet. At this time, as illustrated in FIG. 8, the optical writing device 11 forms the position detection patterns P2 both upstream and downstream of the density detection pattern P1 in the conveyance direction.

In the second case, accordingly, as illustrated in FIG. 9, in a case where the reading device 31 is of the simplex scanning type, the position detection patterns P2 located at the predetermined positions can be detected even when the print sheet is conveyed in either of the document orientations a and b. In the second case, furthermore, as illustrated in FIG. 9, in a case where the reading device 31 is of the duplex scanning type, the position detection patterns P2 located at the predetermined positions can be detected even when the print sheet is conveyed in any one of the document orientations a, b, c, and d.

In the second case, furthermore, since the position at which the reading device 31 starts reading the print sheet does not change depending on the orientation of the print sheet in the conveyance direction, the complexity of the process of setting the read start position, which is performed by the read start position setter 33, is reduced compared to the first case. Also in the second case, as in the first case, since the density detection pattern P1 formed on the print sheet does not change, the amount of toner consumed by the formation of the density detection pattern P1 does not change.

For example, in a third case, as illustrated in FIG. 8, the optical writing device 11 forms the position detection patterns P2 and the density detection pattern P1 at the center on both sides of a print sheet in the conveyance direction of the print sheet. At this time, as illustrated in FIG. 8, the optical writing device 11 forms the position detection patterns P2 both upstream and downstream of the density detection pattern P1 in the conveyance direction.

In the third case, accordingly, as illustrated in FIG. 9, the position detection patterns P2 located at the predetermined positions can be detected even when the print sheet is conveyed in any one of the four document orientations a, b, c, and d, regardless of whether the reading device 31 is of the simplex scanning type or the duplex scanning type.

In the third case, furthermore, since the position at which the reading device 31 starts reading the print sheet does not change depending on the orientation of the print sheet in the conveyance direction, the complexity of the process of setting the read start position, which is performed by the read start position setter 33, is reduced compared to the first case. Note that it is desirable to use an anti-show-through recording medium since the position of the inspection pattern formed on one side of a print sheet and the position of the inspection pattern formed on the other side of the print sheet overlap.

For example, in a fourth case, as illustrated in FIG. 8, the optical writing device 11 forms the position detection patterns P2 and the density detection pattern P1 at a first position (for example, an end on the upstream portion) on the front side (an example of a first surface) of a print sheet in the conveyance direction of the print sheet, and forms the position detection patterns P2 and the density detection pattern P1 at a second position (for example, an end on the downstream portion) on the back side (an example of a second surface opposite to the first surface) of the print sheet in the conveyance direction of the print sheet. At this time, as illustrated in FIG. 8, the optical writing device 11 forms the position detection patterns P2 both upstream and downstream of the density detection pattern P1 in the conveyance direction.

In the fourth case, accordingly, as illustrated in FIG. 9, the position detection patterns P2 located at the predetermined positions can be detected even when the print sheet is conveyed in any one of the four document orientations a, b, c, and d, regardless of whether the reading device 31 is of the simplex scanning type or the duplex scanning type. In addition, the type of the recording medium is not limited since the position of the inspection pattern formed on the front side of the print sheet and the position of the inspection pattern formed on the back side of the print sheet do not overlap.

In the fourth case, however, the position at which the reading device 31 starts reading the print sheet changes depending on the orientation of the print sheet in the conveyance direction, leading to an increase in the complexity of the process of setting the read start position, which is performed by the read start position setter 33. For example, the processing of steps S503 to S508 in the flowchart illustrated in FIG. 5 is repeatedly performed until the position detection patterns P2 are successfully read by the reading device 31.

As described above, in the image forming apparatus 1 according to this embodiment, even when a print sheet is conveyed in any of a plurality of document orientations, the position detection patterns P2 located at the predetermined positions can be detected. As a result, it is possible to prevent a print sheet from being re-read when correcting density unevenness such as vertical streaks and vertical bands of an image, and it is possible to improve usability.

In the embodiment of the present disclosure described above, by way of example but not limitation, an image forming apparatus is applied to a multifunction peripheral having at least two functions among a copy function, a printer function, a scanner function, and a facsimile function. In some embodiments of the present disclosure, an image forming apparatus may be any of image forming apparatuses such as a copying machine, a printer, a scanner, and a facsimile machine.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An image forming apparatus comprising:
an image forming device configured to form a position detection pattern and a density detection pattern on a recording medium according to light emitted from an exposure device;
a reading device configured to read the position detection pattern and the density detection pattern formed on the recording medium, the recording medium being conveyed in one of a plurality of orientations of the recording medium; and
circuitry configured to correct a light intensity of the exposure device, based on the read position detection pattern and the read density detection pattern,
wherein, for any one of the plurality of orientations of the recording medium, the position detection pattern is formed upstream of the density detection pattern in a sub-scanning direction.

2. The image forming apparatus according to claim 1,
wherein the image forming device is configured to form another position detection pattern downstream of the density detection pattern in the sub-scanning direction, in addition to the position detection pattern formed upstream of the density detection pattern.

3. The image forming apparatus according to claim 1,
wherein the image forming device is configured to form the position detection pattern and the density detection pattern on one side of the recording medium.

4. The image forming apparatus according to claim 1,
wherein the image forming device is configured to form the position detection pattern and the density detection pattern at a central portion of one side of the recording medium.

5. The image forming apparatus according to claim 1,
wherein the image forming device is configured to form the position detection pattern and the density detection pattern at a central portion on opposing sides of the recording medium.

6. The image forming apparatus according to claim 1,
wherein the image forming device is configured to form the position detection pattern and the density detection pattern on a first side of the recording medium at a first position in the sub-scanning direction, and form another position detection pattern and another density detection pattern on a second side opposite to the first side of the recording medium at a second position different from the first position in the sub-scanning direction.

7. The image forming apparatus according to claim 3,
wherein the reading device is configured to read opposing sides of the recording medium.

8. A method for correcting a light intensity, comprising:
forming a position detection pattern and a density detection pattern on a recording medium according to light emitted from an exposure device;
reading the position detection pattern and the density detection pattern formed on the recording medium, the recording medium being conveyed in one of a plurality of orientations of the recording medium; and
correcting a light intensity of the exposure device, based on the read position detection pattern and the read density detection pattern,
wherein, for any one of the plurality of orientations of the recording medium, the position detection pattern is formed upstream of the density detection pattern in a sub-scanning direction.

9. The method of claim 8, further comprising:
forming another position detection pattern downstream of the density detection pattern in the sub-scanning direction, in addition to the position detection pattern formed upstream of the density detection pattern.

10. The method of claim 8, wherein the forming includes
forming the position detection pattern and the density detection pattern on one side of the recording medium.

11. The method of claim 8, wherein the forming includes
forming the position detection pattern and the density detection pattern at a central portion of one side of the recording medium.

12. The method of claim 8, wherein the forming includes
forming the position detection pattern and the density detection pattern at a central portion on opposing sides of the recording medium.

13. The method of claim 8, wherein the forming includes
forming the position detection pattern and the density detection pattern on a first side of the recording medium at a first position in the sub-scanning direction; and
forming another position detection pattern and another density detection pattern on a second side opposite to the first side of the recording medium at a second position different from the first position in the sub-scanning direction.

14. An image forming apparatus comprising:
image forming means for forming a position detection pattern and a density detection pattern on a recording medium according to light emitted from an exposure device;
reading means for reading the position detection pattern and the density detection pattern formed on the recording medium, the recording medium being conveyed in one of a plurality of orientations of the recording medium;
controlling means for correcting a light intensity of the exposure device, based on the read position detection pattern and the read density detection pattern,
wherein, for any one of the plurality of orientations of the recording medium, the position detection pattern is formed upstream of the density detection pattern in a sub-scanning direction.
